(19) United States
(12) Patent Application Publication
(10) Pub. No.: US 2013/0208231 A1
(43) Pub. Date: Aug. 15, 2013

(54) Eyeglass Temple Structure

(71) Applicants: Wang Lee Chen Chang, Rende Township (TW); Tsung-Lin Tu, Tainan City (TW)

(72) Inventors: Wang Lee Chen Chang, Rende Township (TW); Tsung-Lin Tu, Tainan City (TW)

(21) Appl. No.: 13/531,626

(22) Filed: Jun. 25, 2012

(30) Foreign Application Priority Data
Feb. 10, 2012 (TW) 101100404

(51) Int. Cl. G02C 5/14

(52) U.S. Cl. 351/121

(57) ABSTRACT

An eyeglass temple structure includes a connection segment extending from the outer side of an eyeglass frame and an eyeglass temple of appropriate flexibility. A slender rod segment is disposed at the end of the connection segment. Bump portions tilting inward are formed at upper and lower ends of the rod segment. Upper and lower flanges extend from top and bottom of an outer side of the eyeglass temple. Continuously extending holes corresponding in position to the upper and lower flanges are formed at levels thereof. The upper and lower flanges are spaced apart to form a space therebetween for receiving the rod segment. The bump portions can be inserted into the holes. The eyeglass temple and the connection segment are pivotally connected to facilitate proper length adjustment of the eyeglass temple and enable the eyeglass temples to be spread apart slightly and worn on the human head conveniently.

### BACKGROUND OF THE INVENTION

1. Technical Field

The present invention provides an eyeglass temple structure characterized in that the length of eyeglass temples pivotally connected to two sides of eyeglasses can be adjusted as needed, or characterized in that end segments of the eyeglass temples can be bent outward before the eyeglasses are put on the human head. Furthermore, the eyeglass temple structure is equipped with a thin plate of appropriate flexibility, and the thin plate enables the eyeglass temples of the eyeglasses to clamp and abut against the human face comfortably as soon as the eyeglass temples come into contact with the human face.

2. Description of Related Art

To meet various user needs, eyeglass frames designed by manufacturers nowadays are always intended to make it easy to change anticipated lenses or usually come in various form in order to provide various functions. Alternatively, the eyeglass temples on the two sides of eyeglass frame can be tied to a cord or formed integrally as a unitary structure, so as to offer choices to users.

In this regard, the present invention is directed to the design of the appearance of eyeglass temples in a manner that the eyeglass temples pivotally connected to the two sides of the eyeglass frame are not only dynamically movable and adjustable but can also abut against the human face of the user comfortably.

### SUMMARY OF THE INVENTION

The present invention improves the functionality of eyeglass temples pivotally connected to two sides of existing eyeglasses serving various purposes, by allowing the length of the eyeglass temples to be adjusted as needed, or allowing end segments of the eyeglass temples to be spread apart before the eyeglasses are put on a user's head. Once the eyeglass temples of the eyeglasses come into contact with the human face, the eyeglass temples of the eyeglasses can clamp and abut against the human face comfortably because a thin plate with appropriate flexibility is formed at each of the eyeglass temples.

The first primary objective of the present invention is to provide an eyeglass temple structure essentially comprising eyeglass temples disposed on two sides of eyeglasses, respectively, and further comprising a connection segment extending from the outer side of an eyeglass frame coupled to a lens with a preset function and the eyeglass temple having appropriate flexibility and being adjacent to the connection segment. A slender rod segment is disposed at an end of the connection segment extending from the outer side of the eyeglass frame, bump portions tilting inward are formed at upper and lower ends of the rod segment. Upper and lower flanges extend from top and bottom of an outer side of the eyeglass temple, and a plurality of continuously extending holes corresponding in position to the upper and lower flanges are formed at the level thereof. The upper and lower flanges are spaced apart to form a space therebetween for receiving the rod segment of the connection segment on the outer side of the eyeglass frame. The bump portions at the upper and lower ends of the rod segment can be inserted into the holes between the upper and lower flanges of the eyeglass temple. Hence, the eyeglass temples are pivotally connected to the connection segments. The eyeglasses can be conveniently put on a human head, because the length of the eyeglass temples can be adjusted as needed, and the eyeglass temples can be spread apart as needed.

The second primary objective of the present invention is to provide an eyeglass temple structure essentially comprising eyeglass temples disposed on two sides of eyeglasses, respectively, and further comprises a connection segment extending from the outer side of an eyeglass frame coupled to a lens with a preset function and the eyeglass temple having appropriate flexibility and being adjacent to the connection segment, wherein a thin plate with appropriate flexibility is formed at the forward end of the eyeglass temple pivotally connected to the connection segment extending from the outer side of the eyeglass frame, such that the eyeglass temples of the eyeglasses can clamp and abut against the human face comfortably.

### BRIEF DESCRIPTION OF THE DRAWINGS

FIG. 1 is a schematic exploded view of an eyeglass temple of the present invention;

FIG. 2 is a schematic perspective view of the eyeglass temple of the present invention;

FIG. 3 is a top view of eyeglasses coupled to the eyeglass temples and worn on a user's head according to the present invention;

FIG. 4 is a schematic view of the eyeglass temple coupled to the eyeglasses and bent outward before the eyeglasses are worn according to the present invention;

FIG. 5 is a top view of the eyeglasses with the eyeglass temples spread apart before the eyeglasses are put on the user's head according to the present invention;

FIG. 6 is a schematic view of adjustment of the length of the eyeglass temple according to an embodiment of the present invention;

FIG. 7 is a top view of the eyeglass temples upon completion of adjustment of the length thereof according to the present invention;

FIG. 8 is a schematic exploded view of the eyeglass temple according to another embodiment of the present invention;

FIG. 9 is a schematic perspective view of the eyeglass temple according to another embodiment of the present invention; and

FIG. 10 is a schematic view of the eyeglass temple bent outward according to another embodiment of the present invention.

### DETAILED DESCRIPTION OF THE EMBODIMENTS OF THE INVENTION

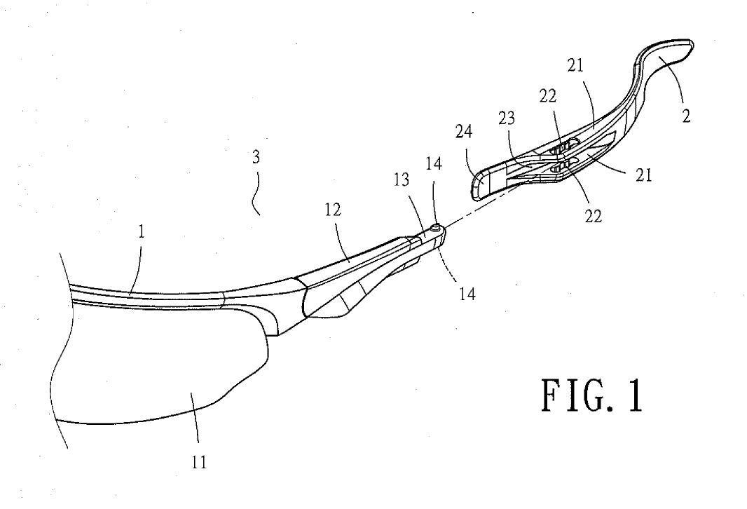

An eyeglass temple structure (shown in FIG. 1) of the present invention essentially comprises eyeglass temples 2 disposed on two sides of eyeglasses 3, respectively, and further comprises a connection segment 12 extending from the outer side of an eyeglass frame 1 coupled to a lens 11 with a preset function and the eyeglass temple 2 which is of appropriate flexibility and adjacent to the connection segment 12.

The eyeglass frame 1 is coupled to the lens 11 with a preset function. The connection segment 12 extends from each of the outer sides of the eyeglass frame 1. A slender rod segment 13 is formed at the end of the connection segment 12. Bump portions 14 tilting inward are disposed at upper and lower ends of the rod segment 13.

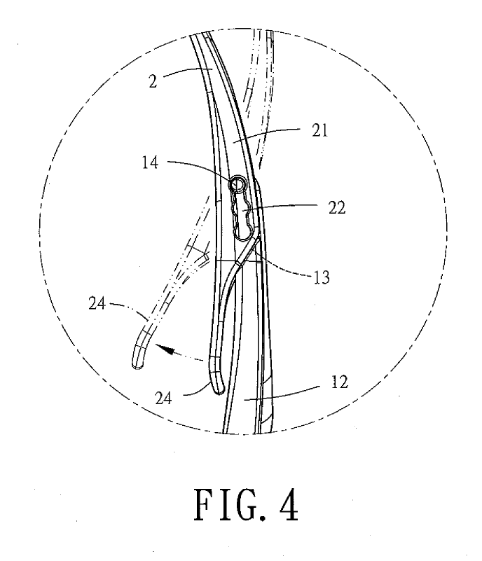

Parts and components of the eyeglass temple 2 depend on the ends of the eyeglass frame 1. Upper and lower flanges 21 extend from the top and the bottom of an outer side of the eyeglass temple 2, respectively. A plurality of continuously extending holes 22 (shown in FIGS. 1, 4) corresponding in position to the upper and lower flanges 21 is formed at the level of the upper and lower flanges 21. The upper and lower flanges 21 are spaced apart to form a space 23 therebetween. A thin plate 24 with appropriate flexibility is formed at the forward end of the eyeglass temple 2.

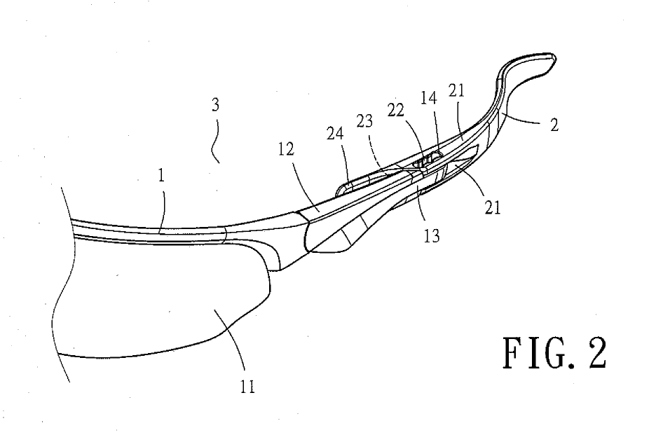

To couple together the eyeglass frame 1 coupled to the lens 11 with a preset function and the eyeglass temple 2 (as shown in FIGS. 1, 2), it is only necessary to insert the rod segment 13 disposed at the end of the connection segment 12 extending from the outer side of the eyeglass frame 1 into the space 23 between the upper and lower flanges 21 of the eyeglass temple 2, and insert the bump portions 14 at the upper and lower ends of the rod segment 13 into holes 22 at the level of the upper and lower flanges 21 of the eyeglass temple 2, such that the eyeglass temple 2 and the connection segment 12 together form the eyeglasses 3 (as shown in FIGS. 1, 4.) characterized by appropriate stability and pivotal connection.

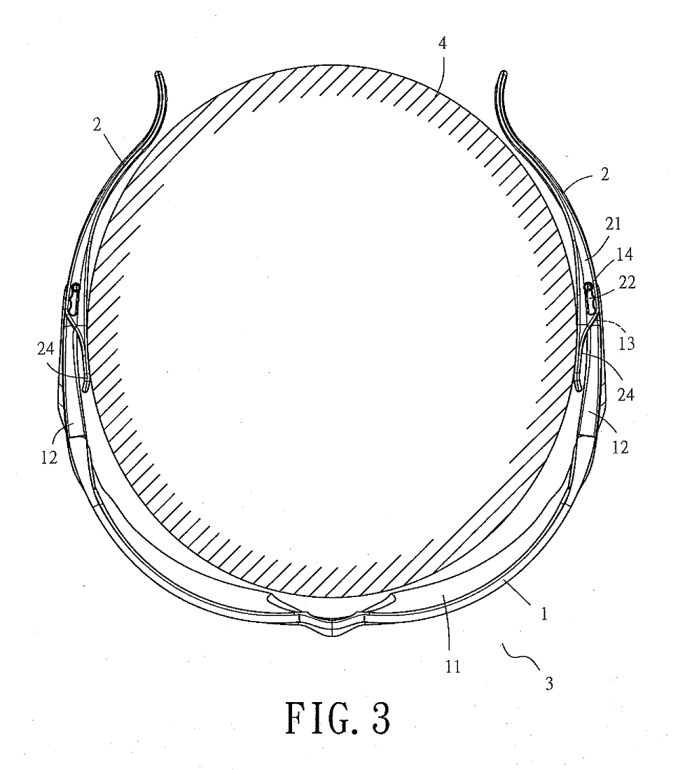

To allow a human head 4 to wear the eyeglasses 3 coupled on two sides thereof to the eyeglass temples 2 (as shown in FIG. 3), the thin plate 24 with appropriate flexibility is formed at the forward end of the eyeglass temple 2 pivotally connected to the connection segment 12 extending from the outer side of the eyeglass frame 1, such that the eyeglasses 3 can clamp and abut against the human face comfortably.

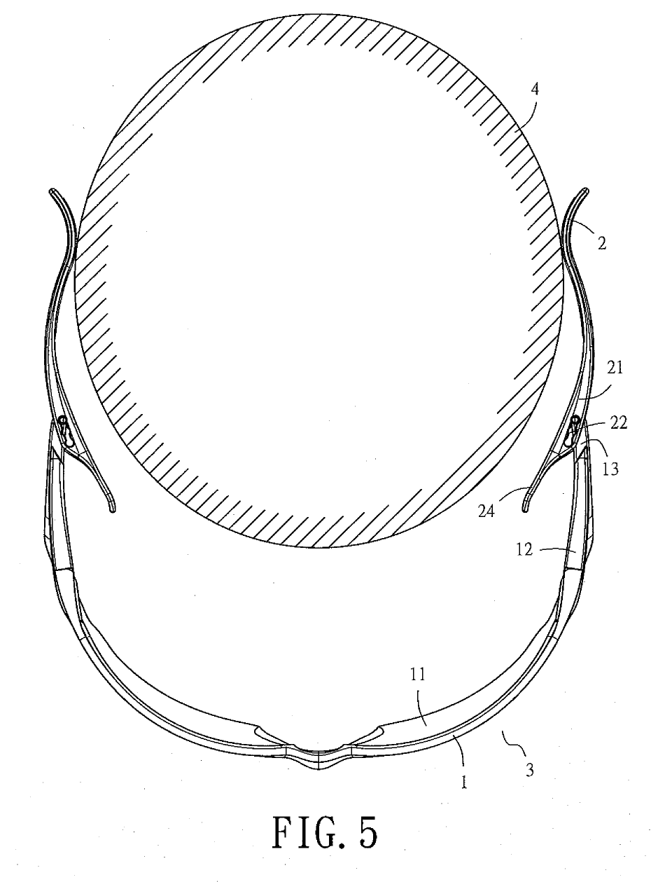

Before putting the eyeglasses 3 on his or her head, a user can bend the eyeglass temple 2 outward slightly (as shown in FIG. 4) by bending outward (in the direction indicated by the arrow and at the position encircled by the dashed line shown in FIG. 4) by hand the eyeglass temple 2 pivotally connected to the connection segment 12 behind the eyeglass frame 1, such that the ends of two said eyeglass temples 2 spread apart (as shown in FIG. 5) to allow the eyeglasses 3 to be put on the human head 4 smoothly. By contrast, the human head has to force its way into the space between two conventional eyeglass temples of a pair of conventional eyeglasses. After the eyeglasses 3 have been completely positioned on the head 4, two said eyeglass temples 2 abut against the temporal regions of the head 4, respectively (as shown in FIG. 3). Hence, not only can the user wear the eyeglasses 3 comfortably, but the distance between two said eyeglass temples 2 can be flexibly adjusted to suit different sizes of human heads.

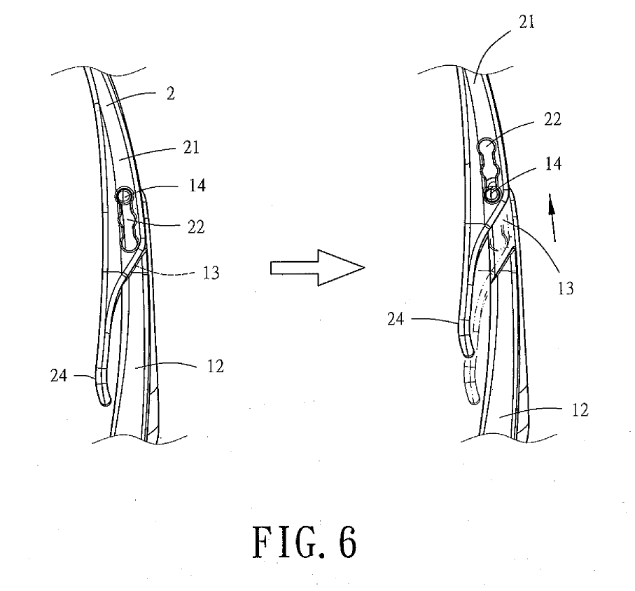

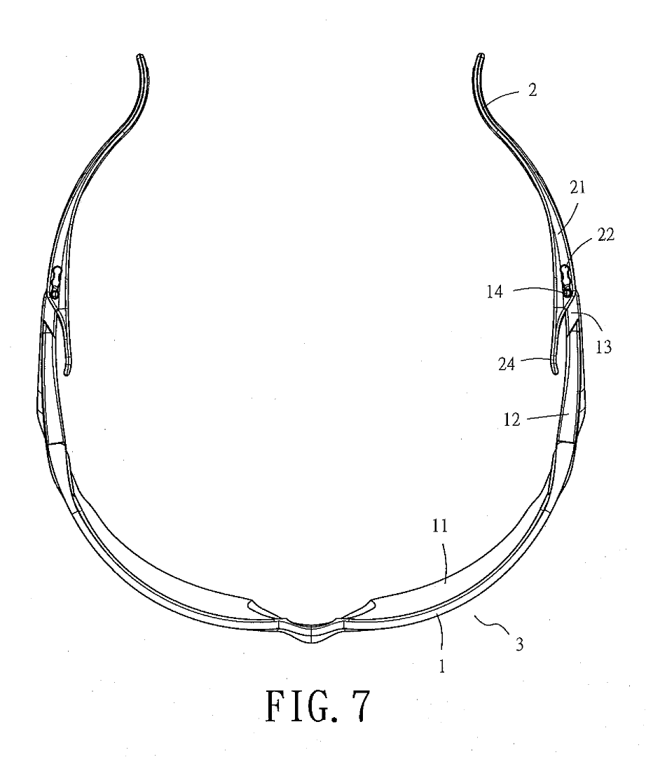

The eyeglass temples 2 disposed on two sides of eyeglasses 3, respectively, can undergo appropriate length adjustment (as shown in FIG. 6) by exerting a force (in the direction indicated by the arrow shown in FIG. 6) on and thereby performing anticipated directional adjustment to the bump portions 14 (at the upper and lower ends of the rod segment 13 disposed at the end of the connection segment 12 extending from the outer side of the eyeglass frame 1) inserted into the holes 22 (corresponding in position to the upper and lower flanges 21 of the eyeglass temple 2), and then stopping the outward pull as soon as the preset length is attained. At this point in time, the bump portions 14 (at the upper and lower ends of the rod segment 13 disposed at the end of the connection segment 12 extending from the outer side of the eyeglass frame 1) are tightly inserted into the holes 22 (corresponding in position to the upper and lower flanges 21 of the eyeglass temple 2) to finalize the adjustment of the length of the eyeglass temple 2 of the eyeglasses 3 (as shown in FIG. 7), such that the eyeglass temples 2 of the eyeglasses 3 suit human heads of different sizes and clamp the human heads flexible and comfortably.

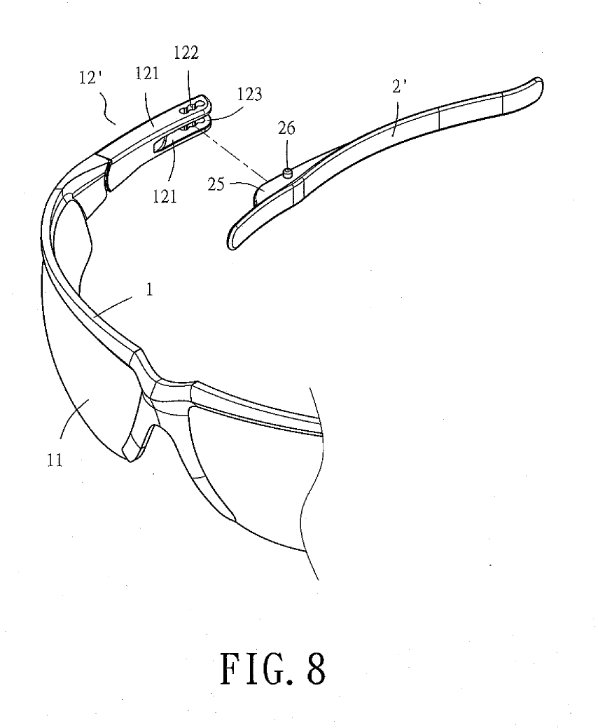

Referring to FIG. 8, in the second embodiment of the eyeglass temple structure of the present invention, regarding the eyeglass temples 2 of FIG. 1 through FIG. 7, the positions of the bump portions 14 of the connection segment 12 and the positions of the continuously extending holes 22 of the eyeglass temples 2 are interchangeable. That is to say, the upper and lower portions 121 are formed at the end of the connection segment 12′, and a plurality of continuously extending holes 122 corresponding in position to the upper and lower portions 121 is formed between the upper and lower portions 121. Furthermore, the upper and lower portions 121 are spaced apart to form a space 123 therebetween. Bump portions 26 are disposed at upper and lower preset positions of upper and lower flanges 25 extending from the outer side at the front ends of an eyeglass temple 2′.

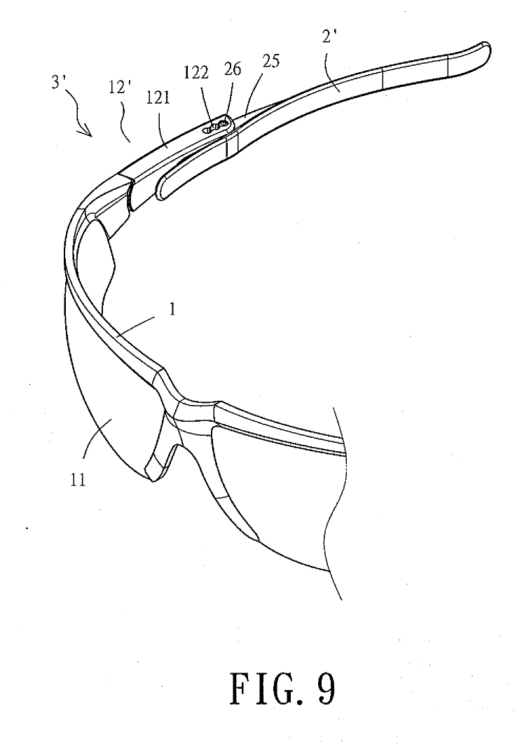

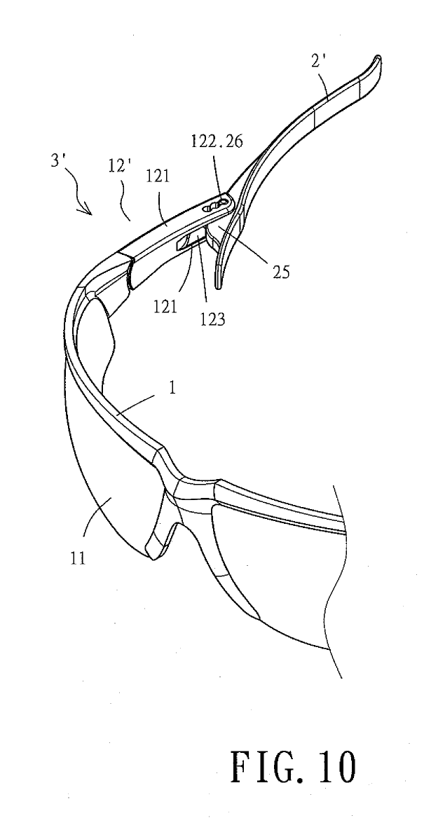

To couple together the eyeglass frame 1 coupled to the lens 11 with a preset function and the eyeglass temple 2′ (as shown in FIGS. 8, 9) it is only necessary to insert the bump portions 26 disposed at the upper and lower preset positions of the upper and lower flanges 25 of the eyeglass temple 2′ into the holes 122 of the upper and lower portions 121 of the connection segment 12′ extending from the outer side of the eyeglass frame 1, such that the connection segment 12′ and the eyeglass temple 2′ together form eyeglasses 3′ (as shown in FIG. 10) characterized by appropriate stability and pivotal connection.

What is claimed is:

1. An eyeglass temple structure, comprising:
eyeglass temples disposed on two sides of eyeglasses, respectively; and
a connection segment extending from an outer side of an eyeglass frame coupled to a lens with a preset function, the connection segment being adjacent to the eyeglass temple,
wherein a rod segment is disposed at an end of the connection segment extending from the outer side of the eyeglass frame, bump portions are formed at upper and lower ends of the rod segment,
wherein upper and lower flanges extend from top and bottom of an outer side of the eyeglass temple, and a plurality of continuously extending holes corresponding in position to the upper and lower flanges are formed at the level thereof,
wherein the upper and lower flanges are spaced apart to form a space therebetween for receiving the rod segment of the connection segment on the outer side of the eyeglass frame, and the bump portions at the upper and lower ends of the rod segment can be inserted into the holes between the upper and lower flanges of the eyeglass temple, such that the eyeglass temple and the connection segment are pivotally connected to facilitate proper adjustment of the length of the eyeglass temple as needed and enable the eyeglass temples to be spread apart slightly and worn on a human head conveniently.

2. The eyeglass temple structure of claim 1, wherein the eyeglass temple pivotally connected to the connection segment is made of a material of appropriate flexibility.

3. The eyeglass temple structure of claim 1, wherein the rod segment disposed at the end of the connection segment pivotally connected to the eyeglass temple is slender.

4. The eyeglass temple structure of claim 1, wherein the bump portions disposed at the upper and lower ends of the rod segment disposed at the end of the connection segment pivotally connected to the eyeglass temple tilt inward.

5. An eyeglass temple structure, comprising:
eyeglass temples disposed on two sides of eyeglasses, respectively; and
a connection segment extending from an outer side of an eyeglass frame coupled to a lens with a preset function, the connection segment being adjacent to the eyeglass temple,
wherein upper and lower portions are formed at an end of the connection segment extending from the outer side of the eyeglass frame,
wherein a plurality of continuously extending holes corresponding in position to the upper and lower portions is formed between the upper and lower portions,
wherein the upper and lower portions are spaced apart to form a space therebetween,
wherein bump portions are formed above and below the upper and lower flanges extending from the outer side of the forward end of the eyeglass temple,
wherein coupling together the connection segment extending from the outer side of the eyeglass frame and the eyeglass temple requires inserting the bump portions above and below the upper and lower flanges extending from the eyeglass temple into holes disposed on the upper and lower portions of the connection segment extending from the outer side of the eyeglass frame, such that the connection segment and the eyeglass temple together form the eyeglasses characterized by appropriate stability and pivotal connection.

6. An eyeglass temple structure, comprising:
eyeglass temples disposed on two sides of eyeglasses, respectively; and
a connection segment extending from an outer side of an eyeglass frame coupled to a lens with a preset function, the connection segment being adjacent to the eyeglass temple,
wherein a thin plate with appropriate flexibility is formed at a forward end of each of the eyeglass temples pivotally connected to the connection segment extending from the outer side of the eyeglass frame, such that the eyeglasses can clamp and abut against a human face comfortably.
